(19) United States
(12) Patent Application Publication
(10) Pub. No.: US 2007/0223216 A1
(43) Pub. Date: Sep. 27, 2007

(54) Artificial candle

(75) Inventors: Bradford Brian Jensen, St. Joseph, MI (US); Roger Donn Bentley, Coloma, MI (US); Kim Irwin McCavit, Saint Joseph, MI (US)

Correspondence Address: PATENT GROUP 2N;JONES DAY, NORTH POINT, 901 LAKESIDE AVENUE, CLEVELAND, OH, 44114, US

(73) Assignee: The Lamson & Sessions Co.

(21) Appl. No.: 11/446,899

(22) Filed: Jun. 5, 2006

Related U.S. Application Data
(60) Provisional application No. 60/786,125, filed on Mar. 27, 2006.

(51) Int. Cl. F21V 35/00

(52) U.S. Cl. 362/161

(57) ABSTRACT

An artificial candle includes a tube that simulates a wax candle and has top and bottom ends. A post extends upward from the top end. A nub, mounted on the post, is diametrically larger than the post. A flame piece simulating a candle flame has a bore configured to receive the nub as the piece is slid down over the post by a user. The bore has a diametrically enlarged section that is axially and radially the same size as the nub to provide the flame piece being slid down over the post with a tactile detent position, and enabling the piece to be slid downward beyond the detent position.

### CROSS-REFERENCE TO RELATED APPLICATION

This application claims the benefit of U.S. Provisional Application No. 60/786,125, filed Mar. 27, 2006.

### TECHNICAL FIELD

This application relates to electric artificial candles.

### BACKGROUND

An artificial candle has a tube simulating a candle and an electric lamp simulating a candle flame.

### SUMMARY

An artificial candle includes a tube that simulates a wax candle and has top and bottom ends. A post extends upward from the top end. A nub, mounted on the post, is diametrically larger than the post. A flame piece simulating a candle flame has a bore configured to receive the post as the piece is slid down over the post by a user. The bore has a diametrically enlarged section that is axially and radially the same size as the nub to provide the flame piece being slid down over the post with a tactile detent position, and enabling the piece to be slid downward beyond the detent position.

Preferably, the flame piece can be slid downward beyond the detent position into contact with the tube. An electric lamp is supported by the post so as to be encased by the flame piece when the flame piece is in the detent position. The lamp is located in the nub.

### BRIEF DESCRIPTION OF THE DRAWINGS

FIG. 1 is a perspective view of an artificial candle and a candleholder;

FIG. 2 is a sectional view of the candle, including a flame piece mounted on a post;

FIG. 3 is a sectional view of the flame piece separated from the post;

FIG. 4 is a sectional view of the flame piece in one mounted position;

FIG. 5 is a sectional view of the flame piece in another mounted position;

FIG. 6 is a sectional view of a second flame piece in one mounted position; and

FIG. 7 is a sectional view of the second flame piece in another mounted position.

### DESCRIPTION

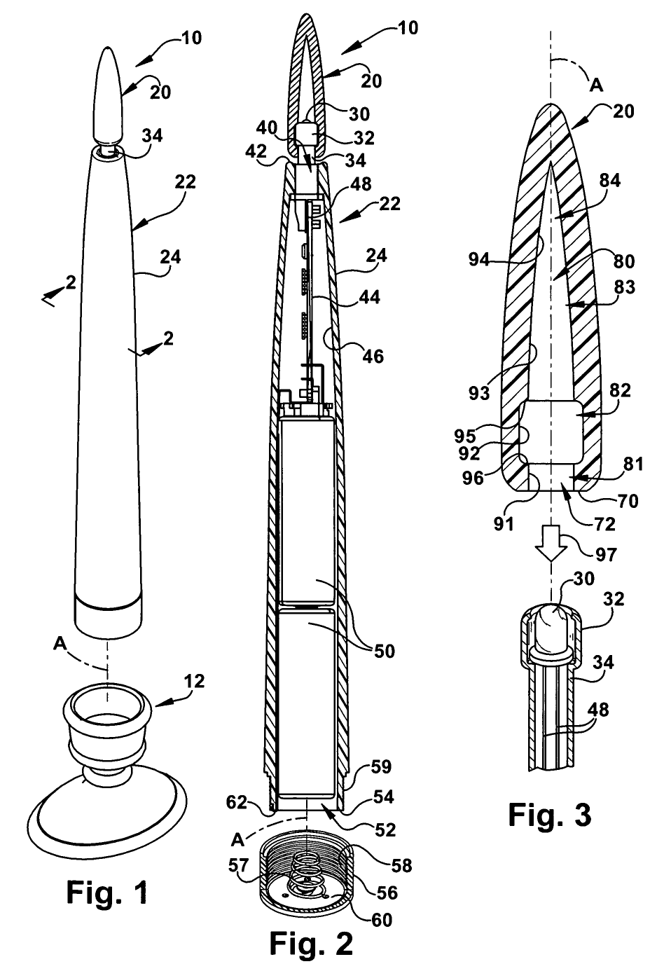

The apparatus shown in FIG. 1 has parts that are examples of the elements recited in the claims. The apparatus thus includes examples of how a person of ordinary skill in the art can make and use the claimed invention. It is described here to meet the requirements of enablement and best mode without imposing limitations that are not recited in the claims.

The apparatus includes an electric artificial candle 10 configured to simulate a lit candle and be mounted in a candle holder 12. The artificial candle 10 includes an elastically flexible translucent flame piece 20 simulating a candle flame and a base 22 simulating a wax candle. In the following description of the candle, directional terms such as “upward” and “vertical” are made only with respect to the orientations shown in the figures.

As shown in FIG. 2, the base 22 includes a tube 24 and an LED lamp 30 both centered on an axis A. The lamp 30 is housed in and supported by a cup-shaped nub 32 at the top of a tubular post 34. The post 34 is diametrically smaller than the cup 32. It extends downward from the cup 32, through a hole 40 in the top 42 of the tube 24, into rigid connection with a flicker circuit 44, which is rigidly fixed to an inside surface 46 of the tube 24. Electric wires 48 extend through the post 34 from the flicker circuit 44 to the LED 30 to power the LED 30. The flicker circuit 44 modulates current supplied by batteries 50 in a random manor so that light emitted by the LED 30 flickers. The lamp 30 is positioned so as to direct its light upward and is encased by the flame piece 20. The light illuminates the translucent flame piece 20 from within, so that the flame piece 20 glows.

The batteries 50 are stacked end-to-end within the tube 24. They are inserted through an access opening 52 at the bottom 54 of the tube 24. The access opening 52 is covered by a cap 56 with a spring 57 that engages the lower battery 50 and an internal screw thread 58 that mates with an external screw thread 59 of the tube 24. The cap 56 retains the batteries 50 in the tube 24. The cap 56 also serves as an on/off switch. To turn on the lamp 30, the cap 56 is turned clockwise until a metal plate 60 in the cap 56 abuts a metal strip 62 mounted in the tube 24 to complete an electrical circuit that powers the flicker circuit 44 to power the lamp 30. To turn off the lamp 30, the cap 56 is turned counterclockwise to move the plate 60 away from the strip 62 and break the circuit.

As shown in FIG. 3, the flame 20 has a bottom surface 70 with an opening 72. A bore 80 extends upward from the opening 72 and comprises cylindrical first, second and third sections 81, 82 and 83 and a conic fourth section 84. These bore sections 81-84 are respectively defined by cylindrical first, second and third surfaces 91, 92 and 93 and a conic surface 94. The second surface 92 is axially and diametrically about the same size as the cup 32. The first and third surfaces 91 and 93 are diametrically about the same size as the post 34. They are respectively separated from the second surface 92 by opposing upper and lower annular shoulder surfaces 95 and 96.

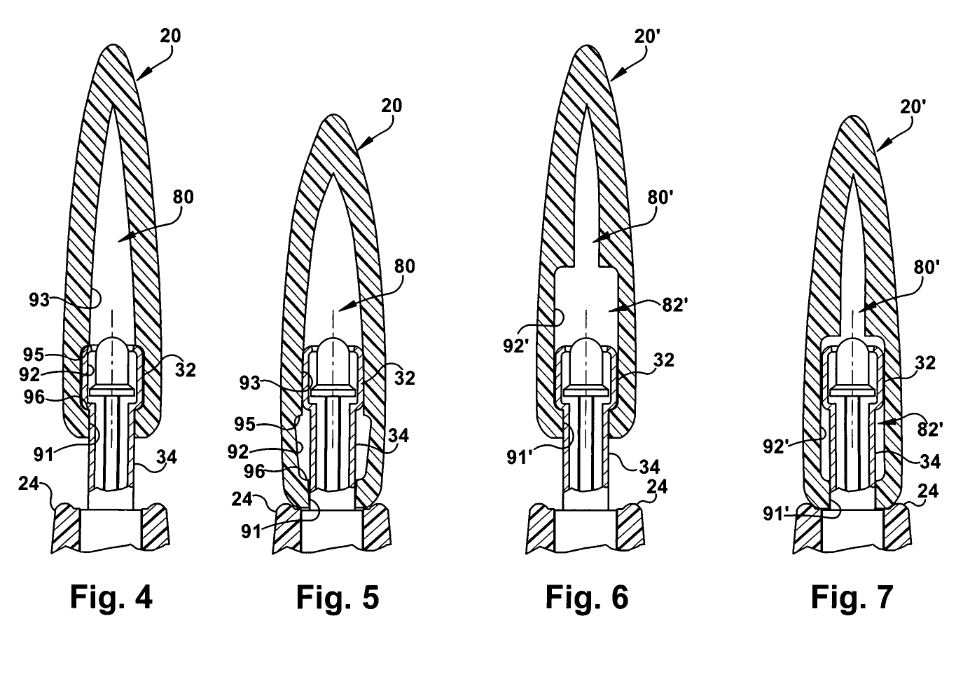

As indicated by arrow 97, the flame 20 can be mounted on the base 22 by being pushed downward over the post 34. The first surface 91 elastically stretches to receive the nub 32. The nub 32 is pushed through the first surface 91 and snaps into place in the radially-enlarged second bore section 82 as shown in FIG. 4.

In FIG. 4, the shoulders 95 and 96 simultaneously engage and releaseably capture the nub 32. The flame 20 is thus in a detent position in that it requires greater force to move the flame 20 out of this position than it takes to move the flame 20 into the position. This detent position is tactile in that the force difference can be felt by the user when pushing or pulling the flame 20 across the detent position. In its detent position, the flame piece 20 is spaced above the tube 24, similar to the manner in which a real flame is spaced above a real candle.

The user can apply a small extra force required to lower the flame 20 beyond the detent position to reduce the clearance between the flame 20 and the tube 24. The flame 20 can even be pushed down to where it contacts the tube 24 and the clearance is eliminated, as in FIG. 5.

The user can also pull the flame piece 20 totally off the tube 24 and replace it with another flame piece. For this purpose, the artificial candle 10 can be sold with flame pieces differing in size, shape and/or color, to be mounted interchangeably on the same base 22. The base 22 and the different flame pieces would be packaged in the same merchandise package for sale to a store customer.

FIG. 6 shows a second flame piece 20′ that is interchangeable with the first flame piece 20 (FIG. 5). It has sections corresponding to those of the first flame piece 20, labeled with corresponding primed numerals. Like the first flame piece 20, the second flame piece 20′ has a lower cylindrical surface 91′ diametrically the same size as the post 34, and configured to elastically stretch to receive the nub 32. The nub 32 can be pushed through the lower cylindrical surface 91 until it snaps into a radially-enlarged bore section 82′ defined by a radially-enlarged cylindrical surface 92′ that is diametrically the same size as the nub 32. The user can push the flame 20′ down to any position within a range of positions, including down into contact with the tube 24 as in FIG. 7.

Unlike the first flame piece 20, the second flame piece 20′ does not have an upper shoulder that abuts the nub 32 as the flame 20′ is pushed down to the tube 24. Therefore, the user tactilely senses the cup 32 entering the radially-enlarged bore section 82′, but does not tactilely sense a resistance against moving the flame 20′ down beyond that.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have elements that do not differ from the literal language of the claims, or if they include equivalent structural elements with insubstantial differences from the literal language of the claims.

1. An artificial candle comprising:
a tube simulating a candle and having top and bottom ends;
a post extending upward from the top end;
a nub mounted on the post and diametrically larger than the post; and
a flame piece simulating a candle flame and having a bore configured to receive the nub as the piece is slid down over the post by a user, the bore having a diametrically enlarged section that is sized with respect to the nub to provide the flame piece being slid down over the post with a tactile detent position, yet enabling the piece to be slid downward beyond the detent position.

2. The candle of claim 1 wherein the flame piece can be slid downward beyond the detent position into contact with the tube.

3. The candle of claim 1 further comprising an electric lamp supported by the post so as to be encased by the flame piece when the flame piece is in the detent position.

4. The candle of claim 3 wherein the lamp is located in the nub.

5. An artificial candle comprising:
a tube simulating a candle and having top and bottom ends;
a post extending upward from the top end;
a nub mounted on the post and diametrically larger than the post; and
a flame piece simulating a candle flame and having a bore configured to receive the nub as the piece is slid down over the post by a user, the bore having a lower section diametrically smaller than the nub and an upper section diametrically larger than the lower section, configured for the nub to pass through the lower bore section and into the upper bore section.

6. The candle of claim 5 wherein the upper bore section is axially about the same size as the nub to provide the flame piece with a detent position that is spaced above the tube.

7. The candle of claim 5 wherein the upper bore section is axially longer than the nub, for the nub to remain in the upper bore section as the flame piece is moved downward toward and into contact with the tube.

8. The candle of claim 5 further comprising an electric lamp supported by the post so as to be encased by the flame piece when the bore receives the post.

9. The candle of claim 8 wherein the lamp is located in the nub.

10. An artificial candle apparatus comprising:
a tube simulating a candle and having top and bottom ends;
a post extending upward from the top end;
a lamp mounted on the post; and
flame pieces simulating a candle flame, configured to be interchangeably mounted over the lamp by a user, and differing from each other in size, shape and/or color.

11. The apparatus of claim 10 wherein the tube, the post, the lamp, and the flame pieces are packaged in a merchandise package.

12. A method for use with the apparatus of claim 10, comprising offering the tube, the post, the lamp and the flame pieces, all packaged together, for sale to a store customer.

13. The candle of claim 1 wherein the enlarged section is axially the same size as the nub.

14. The candle of claim 1 wherein the enlarged section is radially the same size as the nub.

15. An artificial candle comprising:
a tube simulating a candle and having top and bottom ends;
a post structure extending upward from the top end; and
a flame piece simulating a candle flame, configured to be slid down over the post structure into a tactile detent position and further able to be slid down beyond the detent position.

16. The candle of claim 15 wherein the post structure includes a post extending upward from the top end of the tube and a nub mounted on the post, and the flame piece includes a bore for receiving the nub, the bore having a diametrically enlarged section that is sized with respect to the nub to provide the detent position.

17. The candle of claim 15 further comprising an electric lamp supported by the post structure so as to be encased by the flame piece when the flame piece is in the detent position.
